(19) United States
(12) Patent Application Publication
(10) Pub. No.: US 2012/0055275 A1
(43) Pub. Date: Mar. 8, 2012

(54) System and Method for Smart Operation of an Exhaust Hood Using a Protected Monitoring Device

(75) Inventor: Jeffrey S. Lambertson, Danville, CA (US)

(73) Assignee: Streivor Air Systems, Inc., Hayward, CA (US)

(21) Appl. No.: 12/875,105

(22) Filed: Sep. 2, 2010

(51) Int. Cl. G01D 21/00; B23P 19/00; F24C 15/20

(52) U.S. Cl. 73/866.5; 126/299 D; 29/426.1

(57) ABSTRACT

A combination kitchen hood and electronic component enclosure is disclosed. The kitchen hood includes a recess into which kitchen effluents are drawn. The electronic component enclosure is operatively coupled to the kitchen hood and includes a container and a cover removably attachable to the container to seal the electronic component enclosure. The electronic component enclosure defines an interior. The cover is accessible from inside the recess. Upon removal of the cover from the container, the interior of the electronic component enclosure is exposed to the recess, and upon attachment of the cover to the container, the interior of the electronic component enclosure is sealed from the recess.

### BACKGROUND OF THE INVENTION

The present invention relates generally to exhaust hoods and, more particularly, to a system and method of monitoring the properties of the exhaust air of a kitchen hood.

FIG. 1 shows a known kitchen ventilation system (KVS). Cooking equipment such as a stove 10 creates heat, smoke, volatile organic compounds, grease particles, vapor, and other effluents 12 during cooking. A kitchen ventilation system 14 is used to capture, contain and exhaust these effluents 12 to avoid health and fire hazards. The typical KVS 14 includes a hood 16, a plenum 18 with a filter 20 disposed within the hood 16, an exhaust duct 22 in fluid communication with the plenum 18, and a fan 24 and a make up air system 28. The makeup air is distributed via diffuser 29. The space within the hood 16 upstream of the filter 20 is sometimes referred to as the recess or canopy region 21 of the hood; and the region downstream of the filter is sometimes considered a part of the exhaust plenum 18. The fan 24 pulls kitchen air and the effluents 12 into the hood 16, through the filter 20 and into the exhaust plenum 18, then through the duct 22 and out to the atmosphere. In this example, the duct 22 is disposed completely within the ceiling 23. The flow rate at which the air is pulled from the kitchen and through the exhaust system 14 is known as the exhaust rate. This set-up is disclosed in Design Guide 2-Optimizing Makeup Air-Updated 03.15.04 (©2002 California Energy Commission).

Prior devices have been designed to allow electronic devices to be installed on or near the outside of kitchen ventilation hoods such that a probe penetrates into the hood or duct to monitor the properties of the exhaust air. A large percentage of kitchen ventilation hoods, however, are installed in building conditions as described in FIG. 1, and are in close proximity to ceilings and/or walls. As a result, there is often no room available to position measuring devices on the outside of the hood. In addition, measurement equipment often has to be calibrated, serviced and/or replaced over the life of the kitchen hood. Due to limited space and obstructions that are typical in kitchen hoods, the measuring devices are often difficult or impossible to access after the hood has been installed when situated outside the hood, such as when the measuring devices are placed in close proximity to or inside a wall and/or ceiling.

There is a need to be able to monitor the conditions of the KVS and the properties of the exhaust air. More so, there is a need to be able to install, access, and service electronic components within or adjacent to the kitchen hood that monitor the kitchen exhaust system and the properties of the exhaust air that allow for access to maintain, service, and/or replace the electronic components.

In another set-up disclosed in FIG. 2, a first kitchen hood 26, a second kitchen hood 28, and a third kitchen hood 30 are all connected to and in fluid communication with a common exhaust duct 32. Due to configuration of the exhaust system, the exhaust air flowing through the first hood 26 will encounter the highest resistance to air flow, while the flow of the exhaust through the third hood 30 will experience the lowest resistance to air flow. If the exhaust fan is set to provide the first hood 26 with the proper exhaust rate, then the exhaust rate of the third hood 30 will be too high. Accordingly, the owner of the building will be required to pump an equal amount of makeup air back into the kitchen, thereby increasing the costs and potentially disturbing the working environment or effectiveness of the KVS. If the exhaust fan is set to provide the third hood 30 with the proper exhaust rate, then the exhaust rate of the first hood 26 may be too low. Again, where the exhaust rate is too low, the hood will not capture and contain the thermal plume as noted above.

In another set-up disclosed in FIG. 2, a first kitchen hood 26, a second kitchen hood 28, and a third kitchen hood 30 are all connected to and in fluid communication with a common exhaust duct 32, it may be beneficial to have different exhaust rates through each hood as each hood could be installed over varying cooking equipment that generate varying degrees of temperature an effluent plume.

There is a need to be able to accurately monitor and control the exhaust rate and adjust the amount of air that is being pulled out of the kitchen through the exhaust hood to accurately achieve the most beneficial exhaust rate continuously over the life of the exhaust system. This need is particularly acute in systems with multiple kitchen hoods connected to a common exhaust duct as disclosed in FIG. 2.

### BRIEF SUMMARY

The present invention provides a combination kitchen hood and electronic component enclosure. The combination includes a kitchen hood including a recess into which kitchen effluents are drawn; and an electronic component enclosure operatively coupled to the kitchen hood, the electronic component enclosure including a container and a cover removably attachable to the container to seal the electronic component enclosure, the electronic component enclosure defining an interior; wherein the cover is accessible from inside the recess; and wherein upon removal of the cover from the container, the interior of the electronic component enclosure is exposed to the recess, wherein upon attachment of the cover to the container, the interior of the electronic component enclosure is sealed from the recess.

In another aspect, the present invention a method of monitoring conditions within an exhaust hood using a protected monitoring device. The method includes drawing kitchen exhaust into a recess of a kitchen hood and past a probe, the probe extending out of an electronic component enclosure, the electronic component enclosure operatively coupled to the kitchen hood, the electronic component enclosure including a container and a cover removably attachable to the container to seal the electronic component enclosure, the electronic component enclosure defining an interior, wherein the cover is accessible from inside the recess, wherein upon removal of the cover from the container, the interior of the electronic component enclosure is exposed to the recess, wherein upon attachment of the cover to the container, the interior of the electronic component enclosure is sealed from the recess; and monitoring a property of the kitchen exhaust with at least in part a controller connected to the probe and disposed within the electronic component enclosure.

For a further understanding of the nature and advantages of the invention, reference should be made to the following description taken in conjunction with the accompanying figures. It is to be expressly understood, however, that each of the figures is provided for the purpose of illustration and description only and is not intended as a definition of the limits of the embodiments of the present invention.

### BRIEF DESCRIPTION OF THE DRAWINGS

FIG. 1 is a simplified side view of a kitchen appliance and a prior art kitchen exhaust system with a single kitchen appliance and hood.

FIG. 2 is a perspective view of a prior art kitchen exhaust system with multiple hoods and a common exhaust duct.

FIG. 3 is a perspective view of a kitchen exhaust system with multiple hoods, where each hood has an internally adjustable damper device and an electronic component enclosure associated with it, and a common exhaust duct, in accordance with the embodiments of the present invention.

FIG. 4 is a bottom perspective view of a hood, damper device, and enclosure as disclosed in FIG. 3.

FIG. 5 is a top perspective view of the enclosure and damper device of FIG. 4.

FIG. 6 is an exploded view of the damper device and enclosure of FIG. 5.

FIG. 7 is an enlarged bottom perspective view of the damper device of FIG. 5.

FIG. 8 is an exploded view of a damper blade used in the damper device of FIG. 5.

FIG. 9 is a section view of the damper device taken along line A-A in FIG. 5, where the damper blades are in the fully closed position.

FIG. 10 is a section view of the damper device taken along line A-A in FIG. 5, where the damper blades are in the fully open position.

FIGS. 11a-11g are a series of cross sectional views depicting alternative designs of the panels of the housing of the damper device.

FIG. 12 is a front section view of the electronic component enclosure taken along line B-B in FIG. 5.

FIG. 13 is an isometric cutaway view of the enclosure and the removable cover.

FIGS. 14a and 14b are cross sectional views depicting alternative designs of the side panels of the enclosure.

FIG. 15 is a perspective view of an alternate embodiment of the enclosure.

FIG. 16 is a perspective view of an alternate embodiment, where the damper device has multiple electronic enclosures associated with it.

### DETAILED DESCRIPTION OF THE INVENTION

FIG. 3 shows pertinent details of a kitchen hood exhaust system 34 that addresses the foregoing issues. The kitchen exhaust system 34 includes a first hood 36 with a first variable volume damper device 38 and a first electronic component enclosure 40 mounted to the first hood 36. It further includes a second hood 42 with a second damper device 44 and second enclosure 46 mounted to the second hood 42, and a third hood 48 with a third damper device 50 and a third enclosure 52 mounted to the third hood 48.

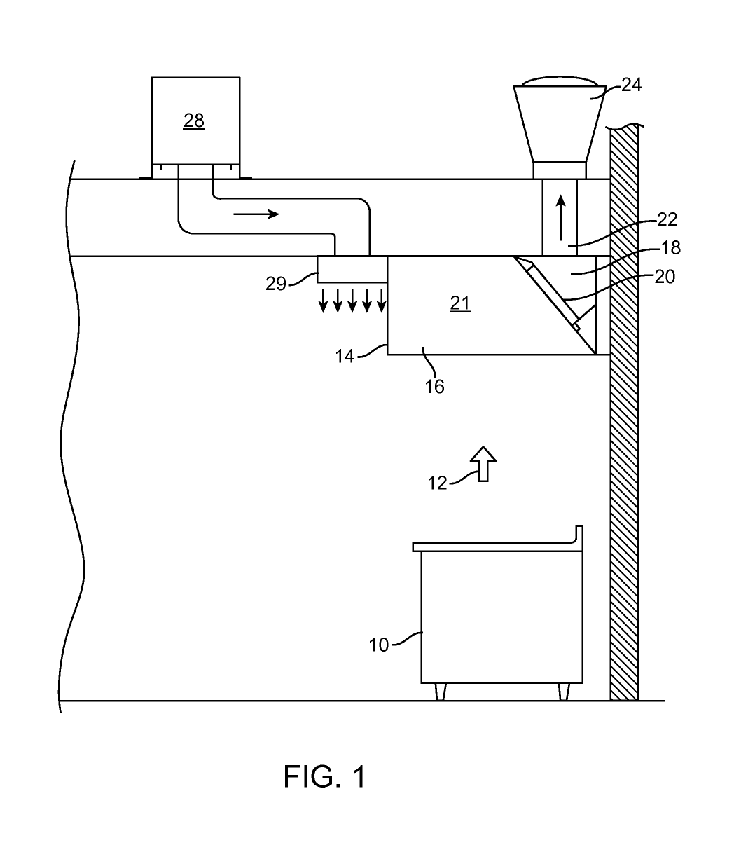

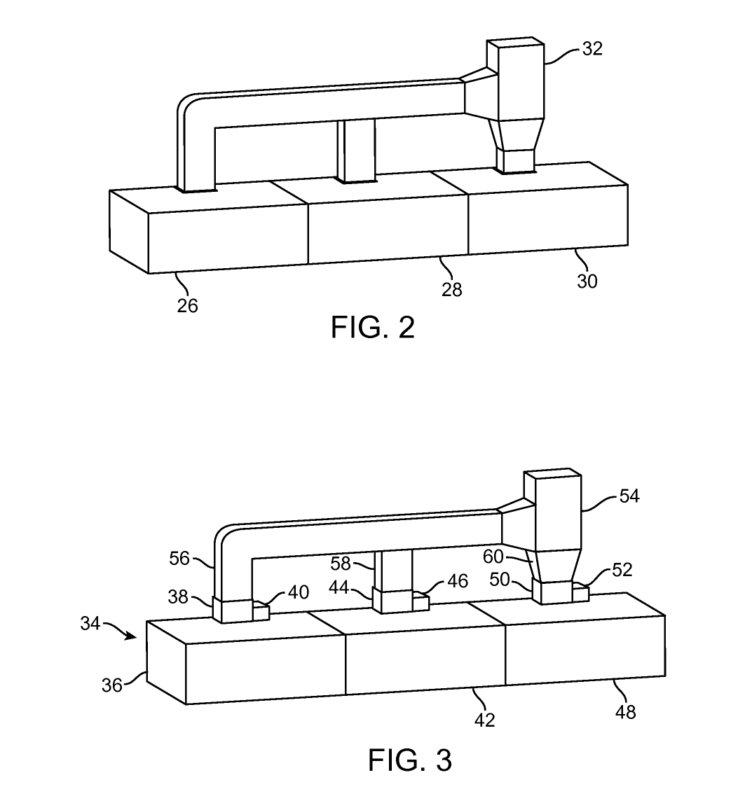

Each damper device 38, 44, 50 is disposed between its respective kitchen hood 36, 42, 48 and a common exhaust duct 54. Each of the first damper device 38, second damper device 44, and third damper device 50 are connected to a first exhaust duct 56, a second exhaust duct 58, and a third exhaust duct 60, respectively. Each of the first exhaust duct 56, the second exhaust duct 58, and the third exhaust duct 60 are connected to the common exhaust duct 54. A single exhaust fan, such as shown in FIG. 1, pulls all exhaust from the first, second and third hoods 36, 42, 48 through the common exhaust duct 54. Each damper device 38, 44, 50 allows for independent adjustment of the exhaust flow through its respective kitchen hood 36, 42, 48 such that each kitchen hood 36, 42, 48 can be set to have an equal and/or proper exhaust rate.

Each electronic component enclosure 40, 46, 52 allows a probe to be positioned in its associated damper device 38, 44, 50 or kitchen hood 36, 42, 48 to monitor, for example, temperature. For brevity, each internally adjustable damper device 38, 44, 50 is alternately referred to herein as simply a damper device. Moreover, the electronic component enclosure 40, 46, 52 is alternately referred to as simply an enclosure.

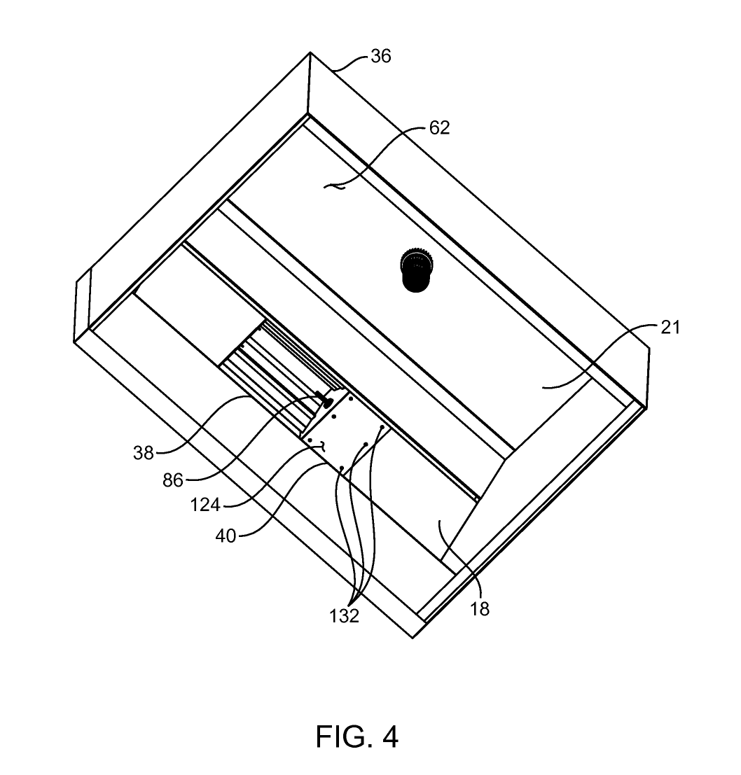

FIG. 4 shows a perspective view as viewed from underneath of the first hood 36, the first damper device 38, and the first enclosure 40. Typically, an air filter is mounted to the hood 36 (as shown in FIG. 1), but in this view the filter has been removed to allow for visualization of inside an exhaust plenum 18 of the hood 36, thus revealing the first damper device 38 and the first enclosure 40. As will be readily understood, only the first damper device 38 and first enclosure 40 will be described herein, but both the second and third damper devices 44, 50 can be the same as the first damper device 40, and both the second and third enclosures 46, 52 can be the same as the first enclosure 40.

As shown in FIGS. 3 and 4, the damper device 38 is operatively coupled to the hood 36, is installed adjacent the hood 36, and can be installed between the hood 36 and the first exhaust duct 56. The damper device 38 is located above and in fluid communication with the hood 36. On the other hand, the damper device 38 could be installed within the hood 36 itself. Moreover, it can be seen that upon removing the filter from the plenum 62, both the damper device 38 and the enclosure 40 are visible and accessible by reaching inside the plenum 62.

Referring now to FIG. 5, an enlarged isometric view of the damper device 38 and enclosure 40 are shown without the kitchen hood. The damper device 38 includes a housing 64 having a sidewall 66 defining an interior 68, the sidewall 66 including a left end panel 70, a right end panel 72, a front panel 74, and a rear panel 76. The housing 64 also defines a first open end 78 and a second open end 80, where the second open end 80 is in fluid communication with the first open end 78. Although the disclosed housing 64 is depicted as having four generally rectangular flat panels 70, 72, 74, 76, other sidewall configurations such as a cylinder are also contemplated. As will be described more fully herein, disposed within the housing 64 is a pair of rotatable, generally rectangular damper blades 82, 84 that extend from the left end panel 70 to the right end panel 72. The damper blades 82, 84 are rotatable to allow a user to vary the resistance that the exhaust fan has to overcome thereby varying the volume rate of air being exhausted through the damper relative to the capabilities of the exhaust fan and the other demands of the exhaust system.

The enclosure 40 can house electronic components adjacent the exhaust plenum 18 and is accessible through the exhaust plenum 18 once the filter is removed. Moreover, the components stored inside the enclosure 40 are accessible from inside the exhaust plenum 18. While the enclosure 40 is adjacent to and accessible from inside the exhaust plenum 18, the enclosure 40 protects the components from the airborne grease and other effluents that are pulled into the exhaust plenum 18 and removed from the kitchen by the exhaust system 34. As will be described more fully herein, in this embodiment a probe 86 such as a temperature probe extends from inside the enclosure 40 and into the housing 64.

The enclosure 40 houses all necessary electronic components to facilitate the temperature probe 86 and allows the components to be connected to a computer or other component. In one embodiment, the computer is also connected to a controller of the exhaust fan, such that as the temperature probe reads a higher temperature, the computer can direct the exhaust fan to run faster. As will be seen, the configuration of the plenum 62 and enclosure 40 allows for a user to have easy access to the electronic components stored inside the enclosure 40.

Referring now to FIGS. 5-10, the dampening device 38 having two dampening blades 82, 84 are disclosed. Although the disclosed device includes two dampening blades, only the first dampening blade 82 will be described herein. It is understood that that second dampening blade 84 can have the same construction as the first dampening blade 82 and can be a mirror image to the first blade 82. The second dampening blade 84 can be independently movable from the first dampening blade 82, although it is envisioned that the second dampening blade 84 can also be interconnected to the first dampening blade 82 through, for example, gearing and/or belts such that movement of one blade will move the other. Moreover, although two dampening blades 82, 84 are described, the system could function with a single dampening blade 82 or three or more dampening blades.

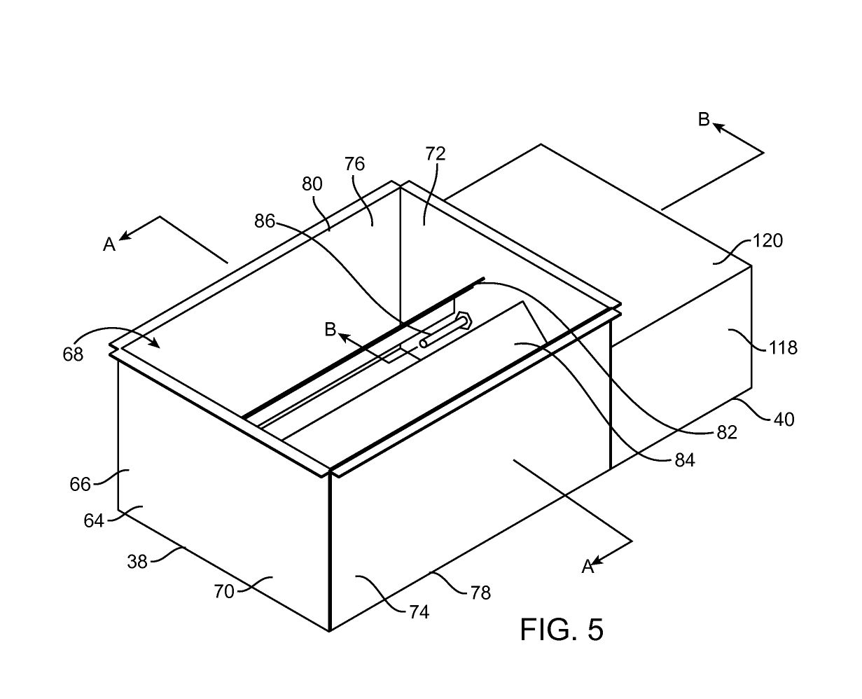

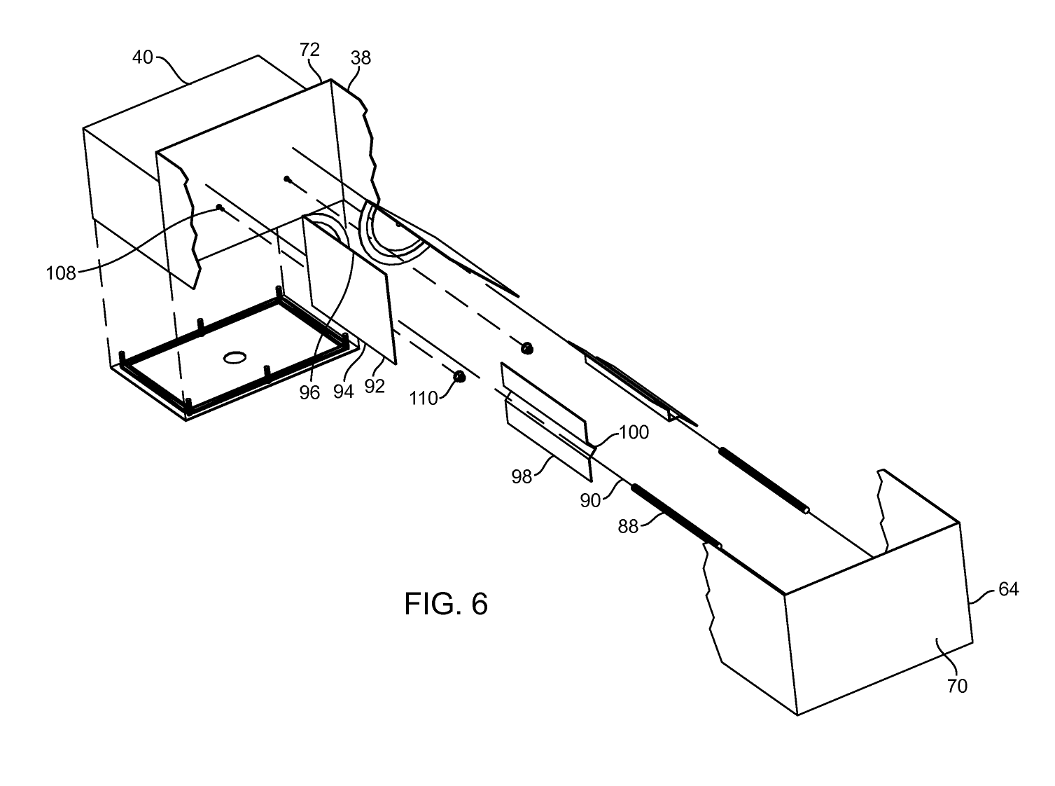

Referring now to the first dampening blade 82 and in particular to FIGS. 6 and 8, a rod 88 extends from the left end panel 70 to the right end panel 72 and is connected on its ends to the end panels 70, 72. In one example, the rod 88 is welded to the housing 64. The rod 88 defines an axis of rotation 90 about which the first damper blade 82 rotates. The damper blade 82 includes a generally rectangular baffle 92 having a leading edge 94 and a trailing edge 96. The damper blade 82 further includes a sandwich panel 98 connected to the baffle 92. The sandwich panel 98 can be welded to the baffle 92. The sandwich panel 98 includes a triangular recess 100 extending along its length. The rod 88 is disposed within the recess 100 between the sandwich panel 98 and the baffle 92 in a relatively tight fit. The rod 88 simultaneously supports the damper blade 82 and allows the damper blade 82 to rotate about the rod 88 and the axis of rotation 90. Other configurations to support and allow a damper blade to rotate within the housing can be used.

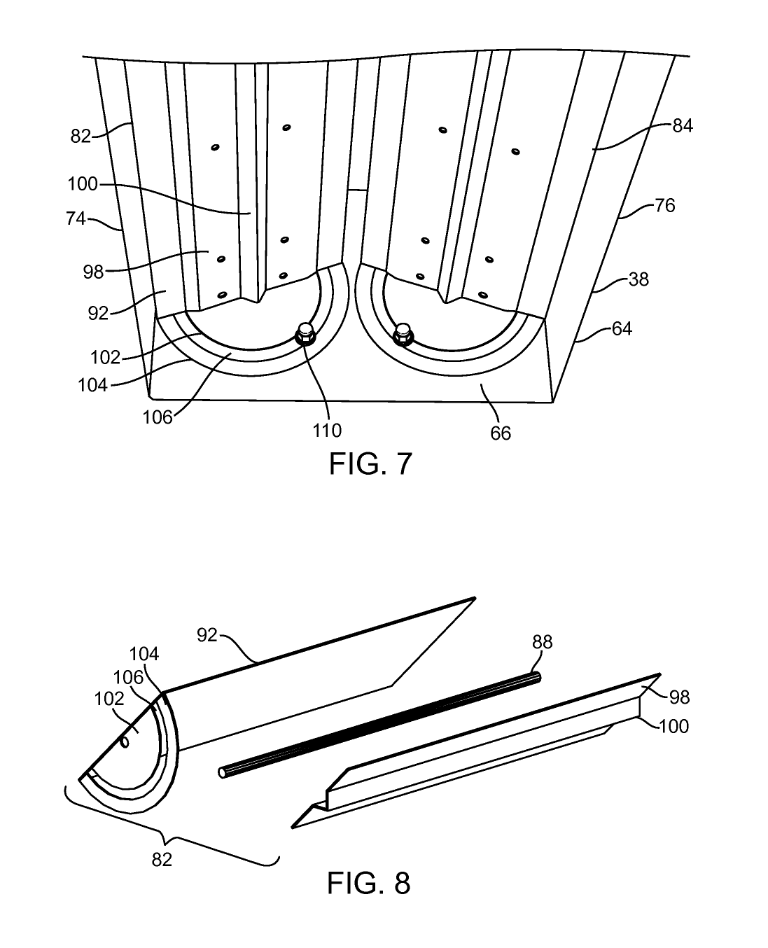

Extending generally perpendicular from an end of the baffle 92 is a semicircular panel 102 and a semicircular arch 104, which can best be seen in FIGS. 7 and 8. Both the panel 102 and the arch 104 are generally adjacent to and parallel to the sidewall 66 of the housing 64 and are symmetric about the axis of rotation 90. A semicircular gap 106 is defined between the panel 102 and the arch 104. In this example, the baffle 92, panel 102, and arch 104 are made from a single piece of sheet metal that is stamped to form the baffle 92, panel 102, arch 104, and gap 106 in a single sheet, where that sheet is then bent such that the panel 102 and arch 104 are perpendicular to the baffle 92. The naming convention of the semicircular panel 102 and semicircular arch 104 is for ease of reference, and no limitation should be read therein. For example, the panel 102 can also be considered an arch.

A threaded stud 108 extends inwardly from the sidewall 66 into the interior 68 of the housing 64. The stud 108 is disposed within the semicircular gap 106, adjacent both the semicircular panel 102 and the semicircular arch 104. A fastener 110 such as a locking bolt is screwed onto the threaded stud 108. While the disclosed fastener 110 may require a wrench, other known fasteners such as wing nuts may also be used that do not require a tool. When fully screwed down, the fastener 110 presses against the panel 102, the arch 104, and the sidewall 66, thereby securing the damper blade 82 in its location by friction against the sidewall 66, seen best in FIGS. 7, 9, and 10

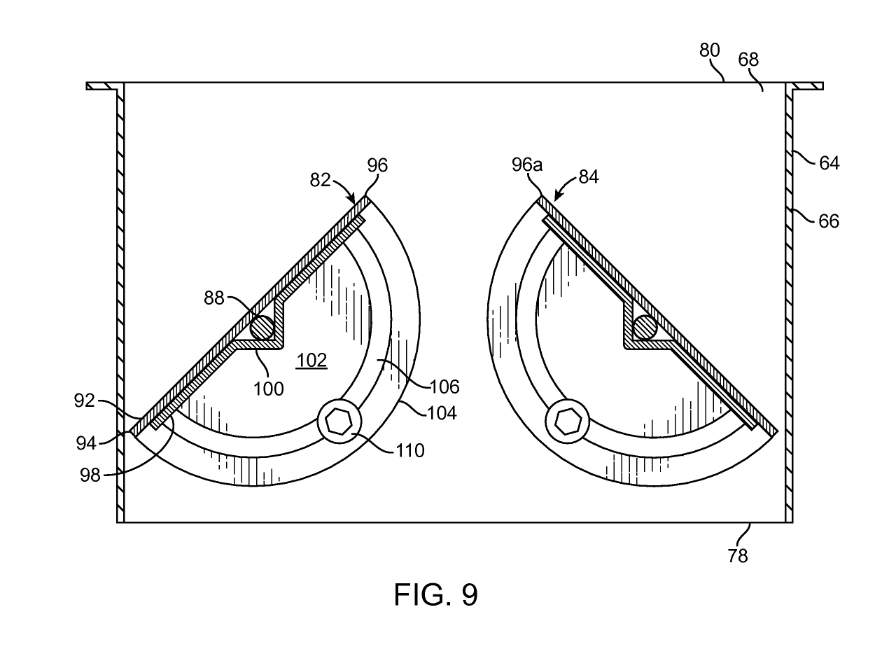

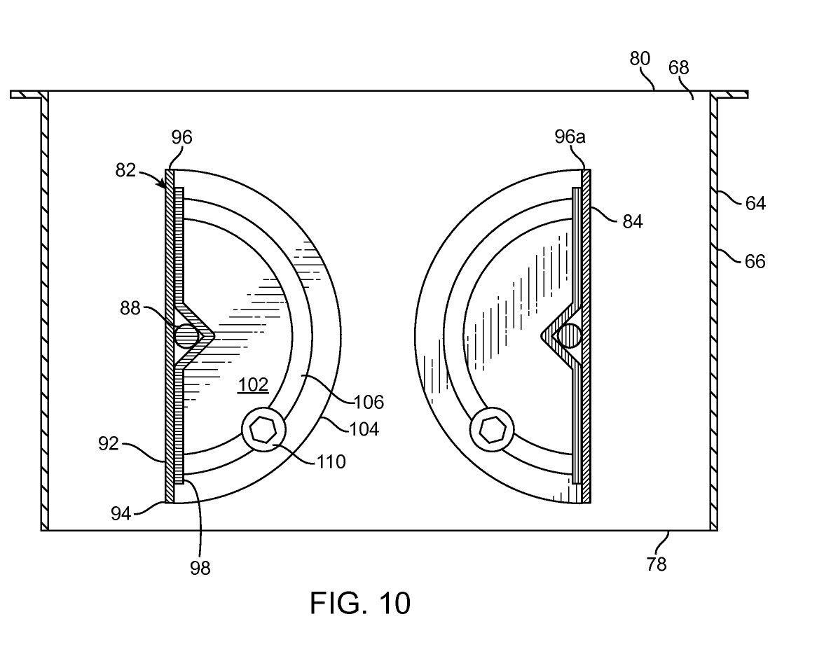

To adjust the air flow resistance of the damper device, a user can remove the filter 20 from the exhaust plenum 18 to gain access to the damper device 38. He or she can reach inside the exhaust plenum 18 into the housing 64, and unscrew the fastener 110 to release the damper blade 82. The user can then rotate the damper blade 82 manually to increase or decrease the resistance to air flow created by the exhaust fan. The user can then refasten the fastener 110 to fix the damper blade 82 in the desired orientation. As shown in FIG. 10, the damper blades 82, 84 can be rotated to a fully open position where the blades are parallel to the direction of air flow. As shown in FIG. 9, the damper blades 82, 84 can also be rotated to a fully closed position. However, in the fully closed position, the damper blades 82, 84 maintain a gap between them at their trailing edges 96, 96a, for example, it is 5% open relative to the first open end or the second open end (95% fully closed), to allow a small amount of exhaust to pass through. Based on this construction, it is possible to adjust the resistance of the damper device and hence the exhaust rate by reaching inside the hood 36 and housing 64. Accordingly, the problem of prior art devices having their adjustment hardware on the outside of the housing 64 is solved by this configuration. Moreover, in setups as shown in FIG. 3, the problem of multiple kitchen hoods connected to a common exhaust duct is also solved. The user can independently adjust the exhaust rates of each kitchen hood such that the exhaust rates of each hood is substantially equal or unequal whichever best meets the demands of the cooking equipment being exhausted under each hood.

In other examples not shown, labels can be disposed adjacent the arch that identify the air flow resistance or exhaust rate for various rotational orientations of the damper blades 82, 84. In other words, the label will identify the exhaust rate that will be achieved when the damper blades 82, 84 are placed in a particular angular orientation. Moreover, means known in the art can be employed to allow setting of discrete, predetermined angular locations corresponding to various exhaust rates.

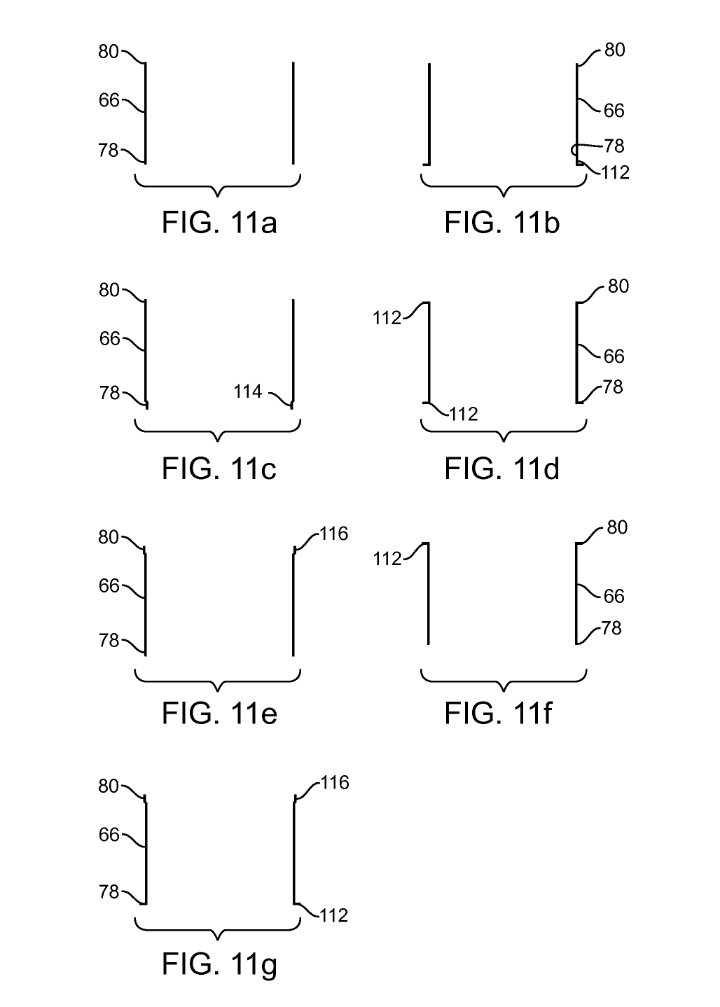

Referring generally now to FIGS. 11a-11g, the sidewall 66 of the housing 64 can have a number of different cross sections that allow for different types of duct and hood connections in the field. FIG. 11a depicts that the sidewall 66 is simply straight at the first open end 78 and the second open end 80. FIG. 11b depicts that the sidewall 66 includes a flange 112 extending perpendicularly outward at the first open end 78. In FIG. 11c, the sidewall 66 includes an inset ridge 114 at the first open end 78. In FIG. 11d, the sidewall includes flanges 112 extending perpendicularly outward at both the first open end 78 and the second open end 80. In FIG. 11e, the sidewall 66 includes an outset ridge 116 at the second open end 80. In FIG. 11f, the sidewall 66 includes a flange 112 extending perpendicularly outward at the second open end 80—this is the configuration shown in FIG. 5. Finally, in FIG. 11g, the sidewall includes a flange 112 extending perpendicularly outward at the first open end 78 and an outset ridge 116 at the second open end 80.

Referring now to FIGS. 4, 5, 12 and 13, the electronic component enclosure 40 is shown. The enclosure 40 is operatively coupled to the hood 36. The enclosure 40 should be so situated relative to the hood 36 such that the probe 86 can extend out of the enclosure 40 and into the air flow captured by the hood 36. Moreover, the enclosure 40 should be accessible from inside the hood 36. In this embodiment, the enclosure 40 is disposed above the hood 36 and is mounted to the hood 36. As mentioned earlier, the enclosure 40 safely houses electronic components away from the harsh high-temperature grease-laden unclean environment of the plenum 62, yet allows easy access to the components from inside the hood 36.

The enclosure 40 is essentially a container 117 with four side panels 118, a top panel 120, and an open bottom 122 with a removable cover 124 that is secured over the open bottom 122. The enclosure 40 defines an interior 125. When the cover 124 is attached to the container 117, the interior 125 is sealed from the exhaust plenum 18. When the cover 124 is detached from the container 117, the interior 125 is exposed to the exhaust plenum 18. The enclosure 40 can be placed adjacent to the damper device 38, where a side panel 118a of the enclosure 40 butts up against the sidewall 66 of the housing 64 of the damper device 38.

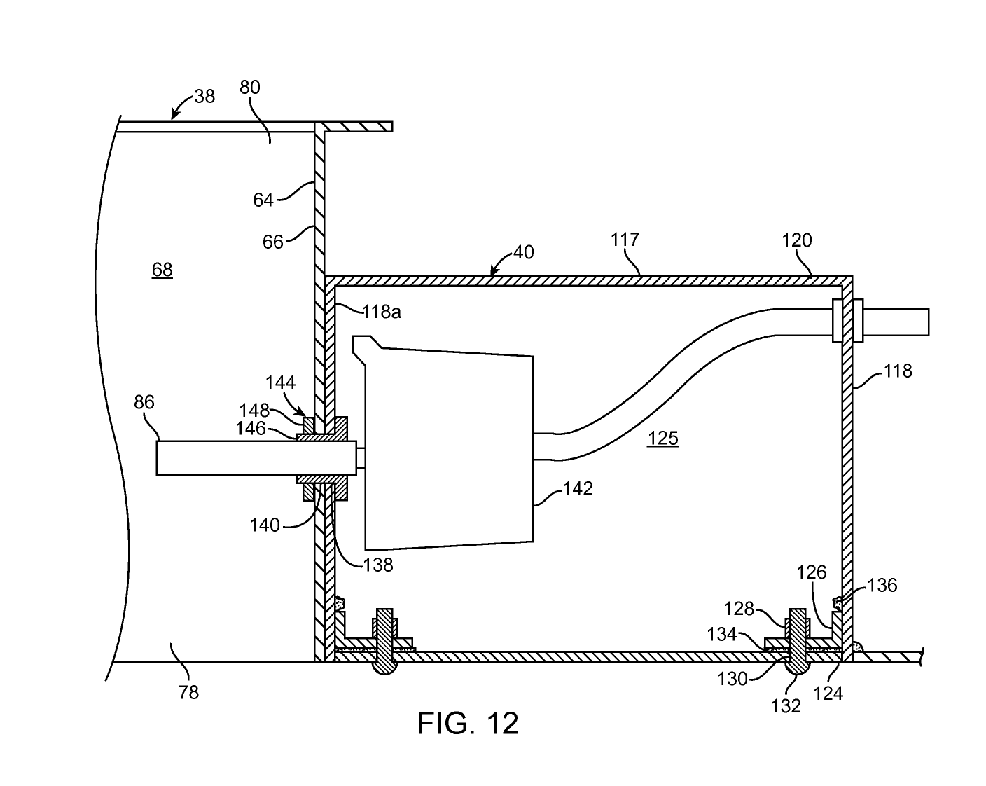

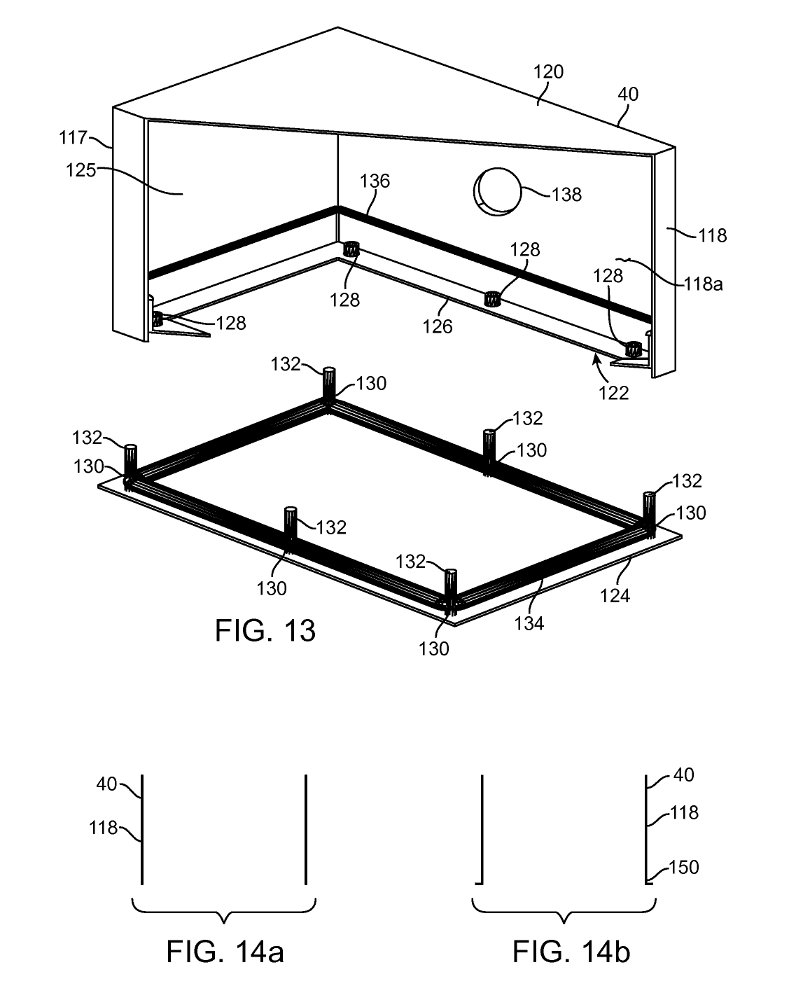

Referring particularly to FIGS. 12 and 13, an L-shaped flange 126 is welded to the side panels 118 adjacent the open bottom 122 and extends inwardly along the perimeter of the open bottom 122. The L-shaped flange 126 includes internally threaded slugs 128 extending upwardly. The removable cover 124 includes through holes 130 coincident with the slugs 128 such that the cover 124 can be fastened to the housing 64 with screws 132 through the through holes 130 into the slugs 128. A gasket 134 is disposed around the perimeter of the removable cover 124, such that when the cover 124 is fastened to the housing 64, the gasket 134 presses against the L-shaped flange 126 to seal the enclosure 40 tightly.

The enclosure 40 includes a continuous fire stop 136 disposed about its side panels 118. The fire stop 136 is a high temperature paste disposed in a gap between the L-shaped flange 126 and the enclosure panels 118. In this example, the L-shaped flange 126 is spot-welded to the enclosure panels 118. Thus, there are gaps between the spot welds and between the flange 126 and the panels 118. The fire stop 136 fills up the gaps and prevents fire and smoke from penetrating, into the enclosure 40 between the side panels 118 and the L-shaped flange 126.

In this example, the enclosure 40 includes an access port 138 in its first side panel 118a. Likewise, the housing 64 of the damper device 38 includes a coincident access port 140 in its side wall 66. An electronic element such as the temperature probe 86 can be disposed within the enclosure 40, extend through the access port 138 in the first side panel 118a in the enclosure 40, the access port 140 in the sidewall 66 of the housing 64, and into the interior 68 of the housing 64. An electronic component 142 such as a controller is mounted within the enclosure 40 and connected to the probe 86.

The access port-138, 140 in the enclosure 40 and housing 38 can be sealed with a quick seal 144 such as one manufactured by Evergreen Tool Co., Model #171 or 899. The quick seal 144 includes an externally threaded nipple 146 and a locking nut 148. Moreover, the nipple 146 can also be internally threaded, with the temperature probe 86 being externally threaded and screwed into the pipe nipple 146. In this manner, the temperature probe 86 can extend into the housing 64 and pass data to the controller 142 without compromising the integrity of the enclosure 40 or subjecting the controller 142 to the harsh high-temperature grease-laden unclean exhaust. Also shown is a conduit extending from controller 142 to allow for the control signal from the controller 142 to be used by other systems that receive the signal, for example, the fan control logic.

If the controller 142 or temperature probe 86 need to be replaced or updated, a user can again simply remove the filter to open the exhaust plenum 18 and gain access to the enclosure 40. As can be seen in FIG. 4, the screws 132 are easily accessible from within the exhaust plenum 18. After removing the screws 132, the removable cover 124 can be removed, and, if necessary, the temperature probe 86 can be screwed out of the quick seal 144. The probe 86 and controller 142 can then be addressed. Once the necessary actions have been taken, the probe 86, controller 142, and quick seal 144 can be reinstalled, the removable cover 124 can be fixed to the enclosure 40, and the filter can be reinstalled.

Referring generally now to FIGS. 14a and 14b, the side panels 118 of the enclosure 40 have a number of different cross sections that allow for different types of connections to the removable cover. FIG. 14a depicts that the side panels 118 are simply straight. FIG. 14b depicts that the side panels 118 include a flange 150 extending outwardly.

FIG. 15 shows a second embodiment of the enclosure 152. Here, the access port is not in the side panel of the enclosure as is shown in FIG. 12. Instead, the access port 154 is disposed within the removable panel 156 itself. Thus, in this example, the temperature probe 86 would extend downwardly into the exhaust plenum 18 of the hood 36 instead of extending into the housing 64 of the damper device 38.

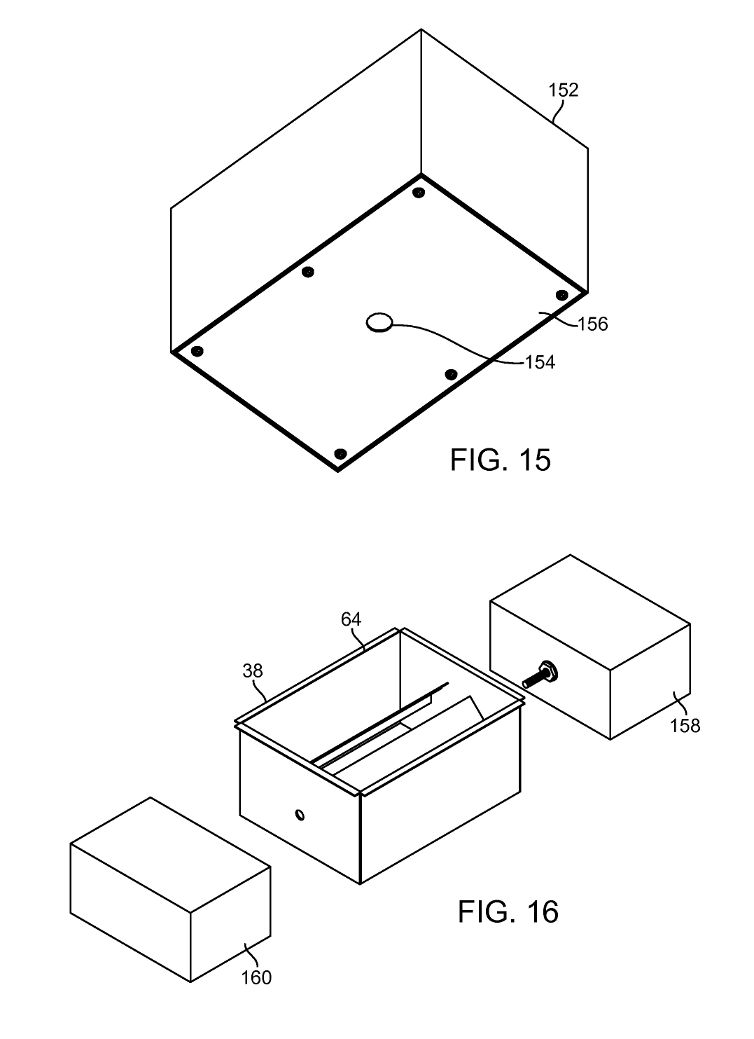

FIG. 16 shows another embodiment where a first enclosure 158 and a second enclosure 160 are both associated with the damper device 38. In this example, a first temperature probe 86 can extend into the housing 64 from the first enclosure 158, while a second temperature probe 86 can extend into the housing 64 from the second enclosure 160. In another example similar to the example shown in FIG. 16, two enclosures are associated with a single damper device, with a first temperature probe extending into the housing from the first enclosure, and a second temperature probe extending into the exhaust plenum 18 from the second enclosure as shown in FIG. 15.

Other uses of the electrical component enclosure can be envisioned. For example, the probe 86 can be a flow meter that can measure the actual exhaust rate, or could be a pitot tube used to measure fluid flow velocity. Over time, the performance of the exhaust fan may deteriorate, thereby lowering the exhaust rate. A flow meter can be used to ensure that the exhaust rate stays at the optimum level or the pitot tube could be used to measure pressure variations. If the exhaust rate dips, the user can simply rotate the damper blades to a position that allows more air to flow. In another example, the damper blades are connected to a small electric motor, through known elements such as belts and/or gears, where a controller is electrically connected to both the temperature sensor, the flow meter and the electric motor. The controller can read the exhaust rate based on the reading of the flow meter and adjust the angular position of the damper blades to ensure that the exhaust rate stays at the optimum level. Similarly, the controller can read the fluid flow velocity using a pitot tube as described herein, and rotate the damper blades according to the exhaust requirements based on the pressure variation. Similarly, the controller can read the temperature of the exhaust using a temperature probe as described herein, and rotate the damper blades according to any exhaust needs required by a temperature increase. For example, if the temperature increases, it may be necessary to increase the exhaust rate.

As will be understood by those skilled in the art, the present invention may be embodied in other specific forms without departing from the essential characteristics thereof. Many other embodiments are possible without deviating from the spirit and scope of the invention. These other embodiments are intended to be included within the scope of the present invention, which is set forth in the following claims.

1. A combination kitchen hood and electronic component enclosure, comprising:
a kitchen hood including a recess into which kitchen effluents are drawn; and
an electronic component enclosure operatively coupled to the kitchen hood, the electronic component enclosure including a container and a cover removably attachable to the container to seal the electronic component enclosure, the electronic component enclosure defining an interior;
wherein the cover is accessible from inside the recess; and
wherein upon removal of the cover from the container, the interior of the electronic component enclosure is exposed to the recess, wherein upon attachment of the cover to the container, the interior of the electronic component enclosure is sealed from the recess.

2. The combination of claim 1, further comprising a temperature probe extending out of an access port in the electronic component enclosure.

3. The combination of claim 2, further comprising a threaded nipple disposed in the access port and a nut disposed on the threaded nipple, the nipple and nut sealing the access port in the electronic component enclosure.

4. The combination of claim 2, the access port being disposed in a sidewall of the electronic component enclosure, the probe extending into an exhaust duct.

5. The combination of claim 2, the access port being disposed in the cover, the probe extending into the plenum of the hood.

6. The combination of claim 1, further comprising a flow meter extending out of an access port in the electronic component enclosure.

7. The combination of claim 1, further comprising a second electronic component enclosure operatively coupled to the kitchen hood, the second electronic component enclosure including a second container and a second cover removably attachable to the container to seal the second electronic component enclosure.

8. The combination of claim 7, further comprising a temperature probe extending through an access port in a sidewall of the electronic component enclosure and a second temperature probe extending through an access port in a sidewall of the second electronic component enclosure.

9. The combination of claim 7, further comprising a temperature probe extending through an access port in a sidewall of the electronic component enclosure and a second temperature probe extending through an access port in the second cover of the second electronic component enclosure.

10. A method of accessing an electronic component within an electronic component enclosure operatively coupled with a kitchen hood, the method comprising:
removing a filter from a kitchen hood to expose a plenum and an electronic component enclosure, the electronic component enclosure being accessible through the plenum, the electronic component enclosure including a container and a cover removably attachable to the container, the electronic component enclosure defining an interior; and
removing the cover from the electronic component enclosure to expose the interior of the electronic component enclosure to the plenum by accessing the cover through the plenum.

11. The method of claim 10, further comprising removing a temperature probe from an access port in a sidewall of the electronic component enclosure.

12. The method of claim 11, further comprising removing a temperature probe from an access port in the cover of the electronic component enclosure.

13. The method of claim 11, further comprising removing an electronic component from the electronic component enclosure.

14. A combination kitchen hood, electronic component enclosure, and damper device comprising:
a kitchen hood having a recess into which kitchen effluents are drawn;
a damper device operatively coupled to the kitchen hood and having a housing, the housing defining an interior, the damper device being in fluid communication with the kitchen hood; and
an electronic component enclosure operatively coupled to the kitchen hood, the electronic component enclosure including a container and a cover removably attachable to the container to seal the electronic component enclosure, the electronic component enclosure defining an interior;
wherein the cover is accessible from inside the recess; and
wherein upon removal of the cover from the container, the interior of the electronic component enclosure is exposed to the recess, wherein upon attachment of the cover to the container, the interior of the electronic component enclosure is sealed from the recess.

15. The combination of claim 14, further comprising a temperature probe extending out of an access port in the electronic component enclosure.

16. The combination of claim 15, wherein the access port is disposed in a sidewall of the electronic component enclosure, and the temperature probe extends into the interior of the housing.

17. The combination of claim 16, wherein the access port is disposed in the cover of the electronic component enclosure, and the temperature probe extends into the recess.

18. The combination of claim 15, further comprising a second electronic component enclosure associated with the kitchen hood, the second electronic component enclosure including a second container with a second cover removably attachable to the container to seal the second electronic component enclosure.

19. The combination of claim 18, further comprising a temperature probe extending through an access port in the sidewall of the electronic component enclosure into the interior of the housing and a second temperature probe extending through an access port in the second cover of the second electronic component enclosure into the recess.

20. A method of monitoring conditions within an exhaust hood using a protected monitoring device, the method comprising:
drawing kitchen exhaust into a recess of a kitchen hood and past a probe,
the probe extending out of an electronic component enclosure, the electronic component enclosure operatively coupled to the kitchen hood, the electronic component enclosure including a container and a cover removably attachable to the container to seal the electronic component enclosure, the electronic component enclosure defining an interior, wherein the cover is accessible from inside the recess, wherein upon removal of the cover from the container, the interior of the electronic component enclosure is exposed to the recess, wherein upon attachment of the cover to the container, the interior of the electronic component enclosure is sealed from the recess; and
monitoring a property of the kitchen exhaust with at least in part a controller connected to the probe and disposed within the electronic component enclosure.
